(19) United States
(12) Patent Application Publication
(10) Pub. No.: US 2024/0072240 A1
(43) Pub. Date: Feb. 29, 2024

(54) LITHIUM METAL SECONDARY BATTERY

(71) Applicant: HONDA MOTOR CO., LTD., Tokyo (JP)

(72) Inventors: Takuya TANIUCHI, Saitama (JP); Terumi FURUTA, Saitama (JP)

(21) Appl. No.: 18/351,507

(22) Filed: Jul. 13, 2023

(30) Foreign Application Priority Data
Aug. 26, 2022 (JP) 2022-135386

(51) Int. Cl. H01M 4/134; H01M 10/0525

(52) U.S. Cl. CPC H01M 4/134; H01M 10/0525; H01M 2004/027

(57) ABSTRACT

Provided is a lithium metal secondary battery having a negative electrode layer, a solid electrolyte layer, and an intermediate layer therebetween, which can suppress the deposition of lithium metal on outer peripheral surface(s) of the intermediate layer along the stacking direction. The lithium metal secondary battery has a negative electrode layer including a lithium metal layer, an intermediate layer, a solid electrolyte layer, and a positive electrode layer stacked in this order, in which at least one of outer peripheral surfaces of the intermediate layer along the stacking direction abuts against and is covered with a protective layer, and the protective layer has ionic conductivity and no electron conductivity.

This application is based on and claims the benefit of priority from Japanese Patent Application No. 2022-135386, filed on 26 Aug. 2022, the content of which is incorporated herein by reference.

### BACKGROUND OF THE INVENTION

### Field of the Invention

The present invention relates to a lithium metal secondary battery.

### Related Art

In recent years, secondary batteries that contribute to an improvement in energy efficiency have been studied and developed to ensure affordable, reliable, sustainable and advanced access to energy for more people. Among the secondary batteries, lithium metal batteries have drawn attention because of their high energy densities.

A known exemplary lithium metal secondary battery includes a negative electrode with a negative electrode current collector, a positive electrode, and a solid electrolyte layer. Such a lithium metal battery may suffer from the impairment of the battery performance due to the deposition of dendrites on the negative electrode layer as charging and discharging are repeated.

Patent Document 1 discloses features which can suppress deposition of metallic lithium and its extension toward the outside of a solid electrolyte, and the stress concentration between the end face of a negative electrode and the end of an electrolyte layer due to the extension, as well as the resultant formation of cracks of the solid electrolyte causing short circuit. Specifically, the features include providing an electrolyte outer edge as an outer edge extending over the outside of a negative electrode lithium metal layer, and configuring the electrolyte outer edge to protrude toward a positive electrode layer. Patent Document 1 also discloses that a layer (intermediate layer) having greater affinity for the metallic lithium than the solid electrolyte layer may be provided between the solid electrolyte layer and the negative electrode current collector.

In addition, Patent Document 2 discloses an approach for the suppression of the formation of a highly resistive layer at an interface of the positive-electrode-layer side of a solid electrolyte layer by interposing an intermediate layer between a positive electrode layer and the solid electrolyte layer.
Patent Document 1: Japanese Unexamined Patent Application, Publication No. 2022-062572
Patent Document 2: Japanese Unexamined Patent Application, Publication No. 2011-044368

### SUMMARY OF THE INVENTION

However, when an intermediate layer is provided between a negative electrode layer and a solid electrolyte layer, as shown in FIG. 4, for example, lithium metal 32a may be deposited on an outer peripheral surface along the stacking direction L of the intermediate layer 5. The deposition of the lithium metal 32a may cause impaired charging and discharging efficiencies, an increase in resistivity, destabilization due to uneven deposition of the lithium metal, and deformation of the electrode due to partial contact, etc.

The present invention has been made in view of the above circumstances, and an object of the present invention is to provide a lithium metal secondary battery having a negative electrode layer, a solid electrolyte layer, and an intermediate layer therebetween, which lithium metal secondary battery can suppress the deposition of lithium metal on outer peripheral surfaces of the intermediate layer along the stacking direction.

A first aspect of the present disclosure relates to a lithium metal secondary battery having a negative electrode layer comprising a lithium metal layer, an intermediate layer, a solid electrolyte layer, and a positive electrode layer stacked in this order, wherein at least one of outer peripheral surfaces of the intermediate layer along the stacking direction abuts against and is covered with a protective layer, and the protective layer has ionic conductivity and no electron conductivity.

According to the first aspect, a lithium metal secondary battery having a negative electrode layer, a solid electrolyte layer, and an intermediate layer therebetween can be provided, which lithium metal secondary battery can suppress the deposition of lithium metal on outer peripheral surfaces of the intermediate layer along the stacking direction.

A second aspect of the present disclosure relates to the lithium metal secondary battery according to the first aspect, wherein the protective layer has an ionic conductivity equal to or higher than the ionic conductivity of the solid electrolyte layer.

According to the second aspect, a lithium metal secondary battery can be provided, which can suppress more favorably the deposition of lithium metal on outer peripheral surfaces of the intermediate layer along the stacking direction.

A third aspect of the present disclosure relates to the lithium metal secondary battery according to the first or second aspect, wherein all of the surfaces on the negative electrode layer side among the surfaces of the protective layer perpendicular to the stacking direction abut against and are covered with an insulating layer.

According to the third aspect, the deposition of lithium metal on surfaces of the protective layer on the negative electrode layer side can be suppressed.

A fourth aspect of the present disclosure relates to the lithium metal secondary battery according to the first or second aspect, wherein the protective layer is monolithically formed with the solid electrolyte layer.

According to the fourth aspect, a lithium metal secondary battery can be provided, which can suppress more favorably the deposition of lithium metal on outer peripheral surfaces of the intermediate layer along the stacking direction even when the intermediate layer is thin.

### BRIEF DESCRIPTION OF THE DRAWINGS

FIG. 1 is a cross-sectional view illustrating the configuration of a lithium metal secondary battery according to a first embodiment;

FIG. 2 is a cross-sectional view illustrating the configuration of a lithium metal secondary battery according to a second embodiment;

FIG. 3 is a cross-sectional view illustrating the configuration of a lithium metal secondary battery according to a third embodiment; and

FIG. 4 is a cross-sectional view illustrating the configuration of a lithium metal secondary battery according to the prior art.

### DETAILED DESCRIPTION OF THE INVENTION

### First Embodiment

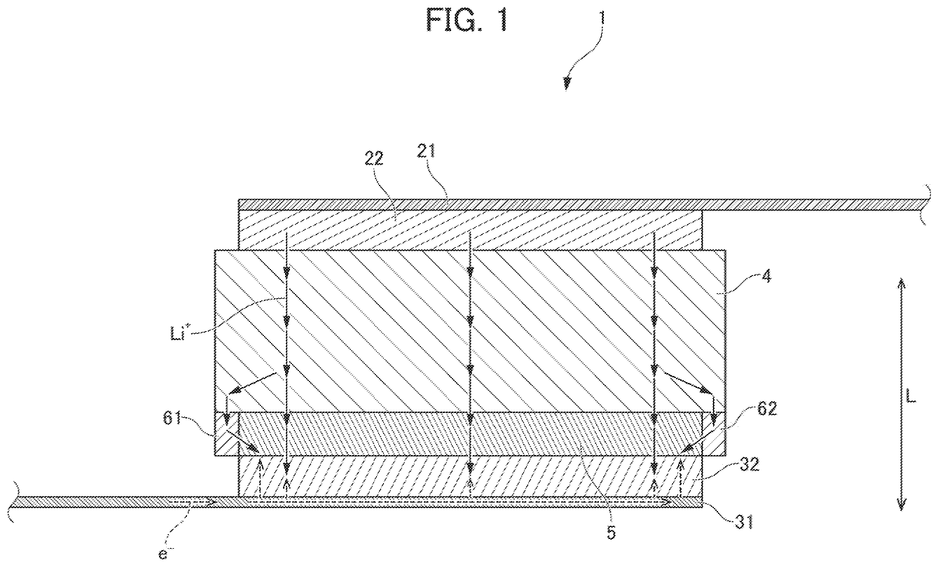

The lithium metal secondary battery 1 according to the present embodiment is a solid-state battery having a solid electrolyte layer 4. The lithium metal secondary battery has a positive electrode layer, a solid electrolyte layer 4, an intermediate layer 5, and a negative electrode layer stacked in this order, wherein the positive electrode layer has a positive electrode current collector 21 and a solid active material layer 22, and the negative electrode layer has a negative electrode current collector 31 and a lithium metal layer 32, as shown in FIG. 1. At least one of outer peripheral surfaces of the intermediate layer 5 along the stacking direction L abuts against and is covered with protective layers 61, 62.

Positive Electrode Layer

The positive electrode current collector 21 may be any current collector which functions to collect any current in the positive electrode layer, and examples of the material thereof include aluminum, aluminum alloys, stainless steels, nickel, iron and titanium, etc., and among these, aluminum, aluminum alloys and stainless steels are preferred. The positive electrode current collector may be, for example, foil-like or plate-like in shape.

The positive electrode active material layer 22 has at least a positive electrode active material. The positive electrode active material contained in the positive electrode active material layer 22 may be similar to active materials contained in a positive electrode layer of common solid-state batteries, and is thus not particularly limited. For lithium ion batteries, the active material may be exemplified by a lithium-containing layered active material, a lithium-containing spinel-structured active material, a lithium-containing olivine-structured active material, etc. Specific examples of the positive electrode active material include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganese oxide (LiMn₂O₄), heteroelement-substituted Li—Mn spinels represented by Li₁+xMn₂-x-yMyO₄ (x+y=2, M=at least one selected from Al, Mg, Co, Fe, Ni, or Zn), lithium titanium oxide (oxides containing Li and Ti), lithium metal phosphate (LiMPO₄, M=at least one selected from Fe, Mn, Co, or Ni), etc.

The positive electrode active material layer 22 preferably has an area on the stacking plane comparable to the area of the intermediate layer 5 on the stacking plane (for example, the area of the positive electrode active material layer 22 may be up to 100%, 90% to 100%, or 80% to 90% of the area of the intermediate layer 5). This feature leads to an increase in energy density of the lithium metal secondary battery 1. Incidentally, it is also conceivable that, from the viewpoint of the prevention of the deposition of the lithium metal on the outer peripheral surfaces of the intermediate layer 5, as described later, the area of the positive electrode active material layer 22 on the stacking plane may be made smaller than the area of the intermediate layer 5 on the stacking plane to minimize the diffusion of Li ions. However, such a feature is disadvantageous since it results in incomplete prevention of the deposition of the lithium metal and additionally in a decrease in energy density of the lithium metal secondary battery 1. Therefore, the positive electrode active material layer 22 is preferably configured such that it has an area on the stacking plane comparable to the area of the intermediate layer 5 on the stacking plane, and that at least one of the outer peripheral surfaces of the intermediate layer 5 along the stacking direction L abuts against and is covered with the protective layers 61, 62, as described later.

The positive electrode active material layer 22 may optionally contain a solid electrolyte from the viewpoint of an improvement in charge transfer medium conductivity. The positive electrode active material layer 22 may further contain a binder, a conductivity aid, etc. These substances may be similar to those commonly used in solid-state batteries.

Negative Electrode Layer

The negative electrode current collector 31 may be any current collector which functions to collect any current in the negative electrode layer, and examples of the material of the negative electrode current collector include nickel, copper, and stainless, etc. The negative electrode current collector may be, for example, foil-like or plate-like in shape.

The lithium metal layer 32 is made of lithium metal or a lithium alloy alone, or a mixture thereof. Examples of the element which can form an alloy with the lithium metal include Al, Mg, K, Na, Ca, Sr, Ba, Si, Ge, Sb, Pb, Sn, In, Zn, etc.

Solid Electrolyte Layer

The solid electrolyte layer 4 contains at least a solid electrolyte material. The solid electrolyte material contained in the solid electrolyte layer can mediate the conduction of a charge transfer medium between the positive electrode active material and the negative electrode active material.

The solid electrolyte material may be any material having charge transfer medium conductivity, i.e., ionic conductivity, and examples thereof include sulfide solid electrolyte materials, oxide solid electrolyte materials, nitride solid electrolyte materials, halide solid electrolyte materials, etc.

For lithium ion batteries, examples of the sulfide solid electrolyte material include Li₂S—P₂S₅, Li₂S—P₂S₅—LiI, etc. It should be noted that the expression “Li₂S—P₂S₅” means a sulfide solid electrolyte material made from an ingredient composition including Li₂S and P₂S₅.

For lithium ion batteries, examples of the oxide solid electrolyte material include NASICON-structured oxides, garnet-structured oxides, perovskite-structured oxides, etc. Examples of the NASICON-structured oxides include oxides containing Li, Al, Ti, P and O (for example, Li_{1.5}Al_{0.5}Ti_{1.5}(PO₄)₃). Examples of the garnet-structured oxides include oxides containing Li, La, Zr and O (for example, Li₇La₃Zr₂O₁₂). Examples of the perovskite-structured oxides include oxides containing Li, La, Ti and O (for example, LiLaTiO₃).

The solid electrolyte layer 4 may contain a binder in addition to the solid electrolyte material.

Intermediate Layer

The intermediate layer 5 is stacked between the lithium metal layer 32 and the solid electrolyte layer 4. If the lithium metal secondary battery 1 lacked the intermediate layer 5, needle-shaped crystals of lithium, called dendrites, would be deposited at an interface between the lithium metal layer 32 and the solid electrolyte layer 4 upon repeated charging and discharging, in particular, during the charging. Once the dendrites are deposited, the electron conductivity at the deposition site would be increased, leading to uneven deposition of the dendrites. As a consequence, the lithium metal layer 32, where the charging and discharging is repeated, would become porous, leading to lower interface adhesiveness, and hence impaired battery performances. In contrast, the presence of the intermediate layer 5 between the lithium metal layer 32 and the solid electrolyte layer 4 allows for the suppression of uneven deposition of the dendrites on the interface between the lithium metal layer 32 and the solid electrolyte layer 4, and for an improvement in the interface adhesiveness.

The intermediate layer 5 has electron conductivity and ionic conductivity. Li ions, for example, can pass through the intermediate layer 5. Thus, upon the repeated charging and discharging of the lithium metal secondary battery 1, Li ions (Li⁺) that move from the solid electrolyte layer 4 toward the lithium metal layer 32 pass through the intermediate layer 5, as shown in FIG. 1. This results in the deposition of the lithium metal between the intermediate layer 5 and the lithium metal layer 32, and thereby even deposition of the lithium metal. Additionally, the intermediate layer 5 is flexible enough to accommodate a volume change of each layer associated with the charging and discharging; accordingly, the lithium metal secondary battery 1 can maintain the interface adhesiveness upon their repeated charging and discharging, leading to an improvement of the durability of the lithium metal secondary battery 1.

Any material may constitute the intermediate layer 5, and the intermediate layer 5 contains, for example, amorphous carbon, metal nanoparticles, and a binder as a binding material.

The amorphous carbon has no ability to react with lithium metal and form an alloy therewith, unlike e.g., graphite and the like, and therefore the amorphous carbon can suppress the formation of the dendrites, and improve cycling characteristics of the lithium metal secondary battery 1. Examples of the amorphous carbon include carbon blacks such as acetylene black, furnace black, and Ketjen black, coke, activated charcoal, etc. The amorphous carbon may be graphitizing carbon (soft carbon), non-graphitizing carbon (hard carbon), CNT (carbon nanotube), fullerene, or graphene.

When the metal nanoparticles are contained in the intermediate layer 5, they contribute to an increase in electron conductivity of the intermediate layer 5, and hence more even deposition of the lithium metal. Any metal nanoparticles may be used, and examples thereof include metal nanoparticles of tin (Sn), silicon (Si), zinc (Zn), magnesium (Mg), gold (Au), platinum (Pt), palladium (Pd), silver (Ag), aluminum (Al), bismuth (Bi), antimony (Sb), etc.

The binder contained in the intermediate layer 5 contributes to the retention of the structure of the intermediate layer 5, and improves the adhesiveness between the particles constituting the intermediate layer 5, and between the intermediate layer 5 and the solid electrolyte layer 4. Any binder may be employed, and binders commonly used in solid-state batteries may be used in the present embodiment. For example, acrylic acid-based polymers, cellulose-based polymers, styrene-based polymers, vinyl acetate-based polymers, urethane-based polymers, fluoroethylene-based polymers, such as PVDF-based polymers may be used.

Protective Layer

The protective layers 61, 62 have ionic conductivity but no electron conductivity. Such layers may each be, for example, a layer containing a solid electrolyte, similarly to the solid electrolyte layer 4. The protective layers 61, 62 allow for the suppression of the deposition of the lithium metal on the outer peripheral surfaces of the intermediate layer 5 along the stacking direction L. For example, when the outer peripheral surfaces of the intermediate layer 5 along the stacking direction L are covered with a simple insulator lacking ionic conductivity, Li ions (Li⁺) are not guided, and thus the lithium metal may be deposited between the intermediate layer 5 and the insulator.

The protective layers 61, 62 abut against at least one of the outer peripheral surfaces of the intermediate layer 5 along the stacking direction L, and cover the intermediate layer 5, as shown in FIG. 1. The at least one of the outer peripheral surfaces is, for example, outer peripheral surface(s) having a risk of short circuit (for example, outer peripheral surface(s) on the side toward which the positive electrode current collector 21 and/or the negative electrode current collector 31 extends), among the outer peripheral surfaces of the intermediate layer 5 along the stacking direction L. The protective layers 61, 62 preferably abut against all of the outer peripheral surfaces of the intermediate layer 5 along the stacking direction L. It should be noted that FIG. 1 is a cross-sectional view, and the protective layers 61, 62 are designated by different reference symbols, but the protective layers 61, 62 may be monolithically formed so as to cover the outer peripheral surfaces of the intermediate layer 5.

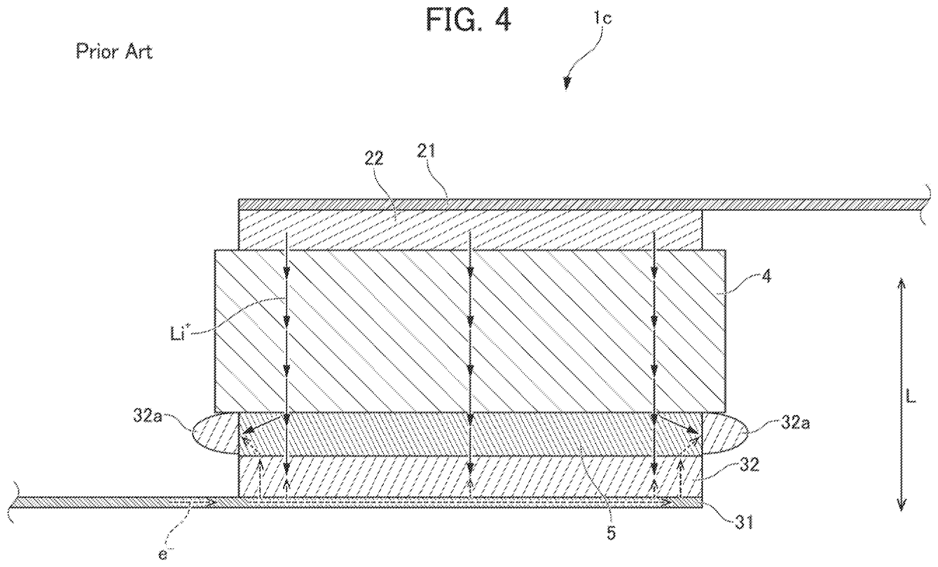

FIG. 4 is a diagram illustrating a lithium metal secondary battery 1c according to the prior art, in which the lithium metal secondary battery 1c lacks the protective layers 61, 62. As shown in FIG. 4, since the intermediate layer 5 has Li ion (Li⁺) conductivity, and electron conductivity, i.e., the ability to conduct electrons e⁻, electrons e⁻ are supplied across the intermediate layer 5. Consequently, the lithium metal 32a is deposited on the outer peripheral surfaces of the intermediate layer 5 along the stacking direction L. Such deposition of the lithium metal 32a on the outer peripheral surfaces of the intermediate layer 5 may cause, in the lithium metal secondary battery 1c, impaired charging and discharging efficiencies, an increase in resistivity, and impaired safety due to uneven deposition of the lithium metal 32a. Additionally, the deposition of the lithium metal 32a deposited on the outer peripheral surfaces of the intermediate layer 5 occurs at an end of lithium metal layer 32, and thus the end of the lithium metal layer 32 has more deposits than the central portion thereof; this may result in the state of partial contact, and hence deformation of the negative electrode layer as well.

The lithium metal secondary battery 1 according to the present embodiment has at least one of the outer peripheral surfaces of the intermediate layer 5 along the stacking direction L at least covered with the protective layers 61, 62, and allows for the suppression of the deposition of the lithium metal on the outer peripheral surface(s).

The protective layers 61, 62 preferably have an ionic conductivity equal to or higher than the ionic conductivity of the solid electrolyte layer 4. This feature allows the Li ions (Li⁺) to be guided to the protective layers 61, 62 and more preferable suppression of the deposition of the lithium metal on the outer peripheral surfaces of the intermediate layer 5, as shown in FIG. 1. The feature is realized, for example, when the percentage of the binder contained in the protective layers 61, 62 is lower than the percentage of the binder contained in the solid electrolyte layer 4. Besides, the feature mentioned above may be realized by employing, as the solid electrolyte material contained in the protective layers 61, 62, a solid electrolyte material having a higher Li ion conductivity than the solid electrolyte material contained in the solid electrolyte layer 4.

The protective layers 61, 62 preferably have an abutting surface against the solid electrolyte layer 4. This makes it possible to guide the Li ions (Li⁺) from the solid electrolyte layer 4.

In FIG. 1, the protective layers 61, 62 extend to the interface between the intermediate layer 5 and the lithium metal layer 32, but the extension of the protective layers 61, 62 is not limited to this configuration. The protective layers 61, 62 need only to at least abut against at least one of the outer peripheral surfaces of the intermediate layer 5 along the stacking direction L. For example, the protective layers 61, 62 may extend at least partially to the outer peripheral surfaces of the lithium metal layer 32 along the stacking direction L. In particular, when the protective layers 61, 62 contain a material highly reactive with the Li metal (for example, a sulfide-based solid electrolyte or an oxide-based solid electrolyte), the protective layers 61, 62 are preferably arranged such that the protective layers 61, 62 do not extend to the interface between the intermediate layer 5 and the lithium metal layer 32, to avoid the contact of the protective layers 61, 62 with the lithium metal layer 32. On the other hand, when the protective layers 61, 62 are made of a material less reactive with the Li metal, the protective layers 61, 62 may extend to the outer peripheral surfaces of the lithium metal layer 32.

Method for Producing Lithium Metal Secondary Battery

The lithium metal secondary battery 1 according to the present embodiment is produced by stacking the negative electrode layer, the intermediate layer 5, the solid electrolyte layer 4, and the positive electrode layer in this order, and forming the protective layers 61, 62 on the outer peripheral surfaces of the intermediate layer 5 along the stacking direction L. Incidentally, following the stacking, the stacked layers may be optionally pressed to integrate them. Further, a plurality of the afore-mentioned structural units as unit batteries may be stacked.

The step of forming the positive electrode layer may include, for example, applying a mixture slurry containing components forming the positive electrode active material layer to the positive electrode current collector. Any means for the application may be employed, and an inkjet technique, a screen printing technique, a CVD technique, a sputtering technique, etc. may be used, and known application means such as doctor blade and dipping may be employed as well. The step of forming the negative electrode layer may include, for example, joining the lithium metal with the negative electrode current collector using a clad material, or the like.

The step of forming the solid electrolyte layer 4 may include applying a slurry containing a solid electrolyte material according to a procedure similar to the procedure for the above-mentioned positive electrode layer, or providing a three-dimensional structure such as a nonwoven fabric as a support and dipping the support into a slurry containing a solid electrolyte material to form the solid electrolyte layer 4.

The step of forming the intermediate layer 5 may include applying a slurry containing a material for forming the intermediate layer 5 according to a procedure similar to the procedure for the above-mentioned positive electrode layer.

The step of forming the protective layers 61, 62 on the outer peripheral surfaces of the intermediate layer 5 along the stacking direction L may include, for example, drying the layers formed in the steps, stacking the layers, and subsequently applying a slurry containing a material constituting the protective layers 61, 62 to the outer peripheral surfaces of the intermediate layer 5. Alternatively, the step of forming the protective layers 61, 62 may include applying a slurry containing a material constituting the protective layers 61, 62 to the solid electrolyte layer 4 in the step of forming the intermediate layer 5. Alternatively, the step of forming the protective layers 61, 62 may include preparing a sheet in a separate step by integrating the intermediate layer 5 and the protective layers 61, 62, and subsequently transferring the sheet to the solid electrolyte layer 4.

The step of forming (arranging) the negative electrode layer is performed after the intermediate layer 5 and the protective layers 61, 62 are arranged.

Next, the lithium metal secondary batteries according to other embodiments of the present invention will be described. Hereinafter, the features similar to those in the first embodiment are designated by the same reference numerals in the drawings, and descriptions thereof may be omitted.

### Second Embodiment

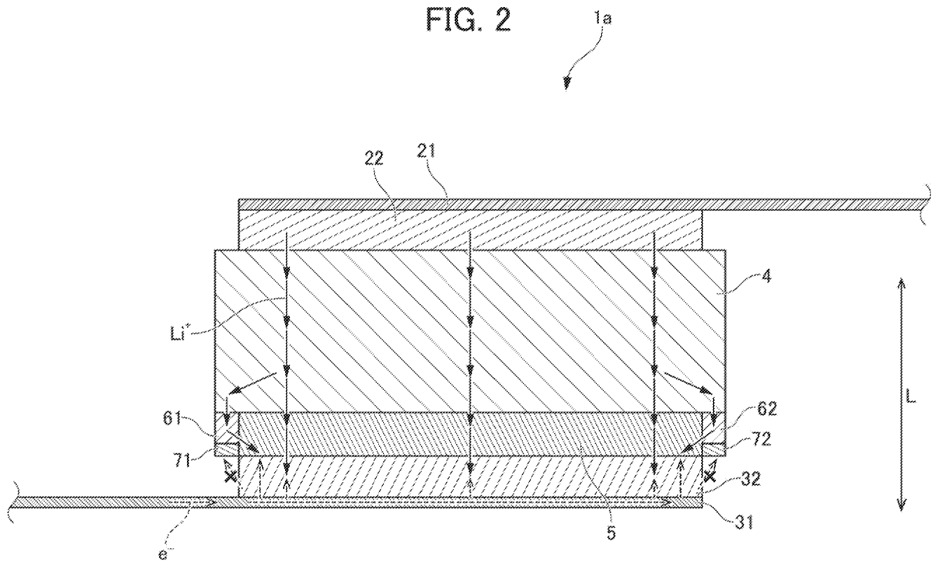

In the lithium metal secondary battery 1a according to this embodiment, all of the surfaces on the negative electrode layer side, among the surfaces of the protective layers 61, 62 perpendicular to the stacking direction L, each abut against and are covered with insulating layers 71, 72, as shown in FIG. 2. This feature allows for reliable blockage of the supply of electrons e⁻ from the outer peripheral surfaces of the lithium metal layer 32 along the stacking direction L to the protective layers 61, 62, as schematically shown in FIG. 2. This makes it possible to suppress the deposition of lithium metal on the surfaces on the negative electrode layer side of the protective layers 61, 62.

Any material exhibiting insulation properties may be used as the material constituting the insulating layers 71, 72, and for example, an insulating resin may be employed.

### Third Embodiment

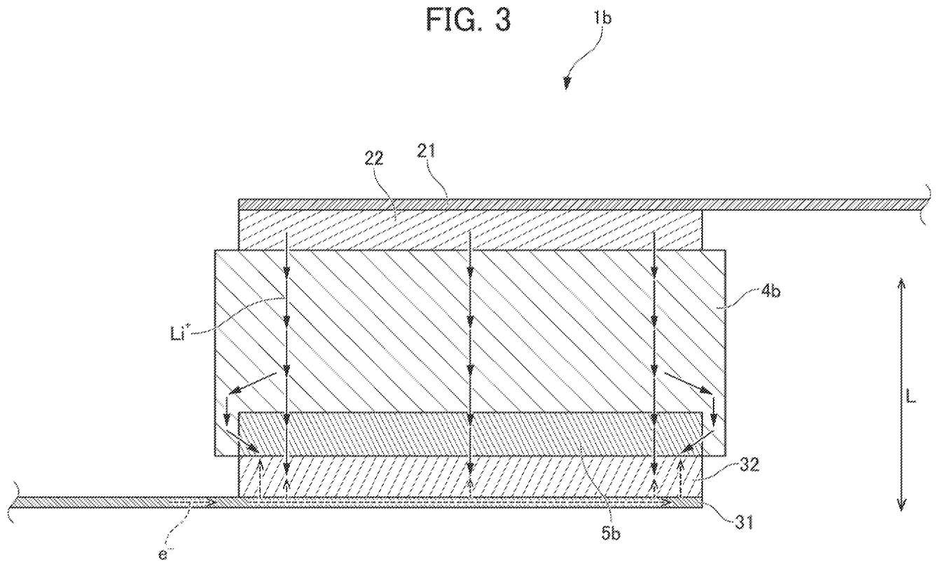

The lithium metal secondary battery 1b according to a third embodiment has a solid electrolyte layer 4b which abuts against and covers all of the outer peripheral surfaces of the intermediate layer 5b along the stacking direction L, as shown in FIG. 3. In other words, the solid electrolyte layer 4b functions as both the solid electrolyte layer 4 and the protective layers 61, 62 in other embodiments described above. More specifically, the protective layer according to this embodiment is monolithically formed with the solid electrolyte layer, and is formed by permitting the solid electrolyte layer to extend such that the solid electrolyte layer abuts against and covers all of the outer peripheral surfaces of the intermediate layer 5b along the stacking direction L. Since the solid electrolyte layer 4b has ionic conductivity but no electron conductivity, the feature described above achieves the similar effects to the embodiments described above.

Method for Producing Lithium Metal Secondary Battery

The method for producing the lithium metal secondary battery 1b according to the third embodiment may include, for example, stacking a dried intermediate layer 5b on an undried solid electrolyte layer 4b, and embedding the intermediate layer 5b into the solid electrolyte layer 4b to avoid the exposure of the outer peripheral surfaces. This makes it possible to cover the outer peripheral surface(s) favorably with the protective layer, even when the intermediate layer 5b is thin. Further, the step allows all of the outer peripheral surfaces of the intermediate layer 5b along the stacking direction L to abut against and be covered with the solid electrolyte layer 4b.

Preferred embodiments of the present invention have been described hereinabove, but the present invention is not limited to the embodiments, and the present invention also encompasses modifications and improvements without departing from the spirit of the present invention.

### EXPLANATION OF REFERENCE NUMERALS

1, 1a, 1b lithium metal secondary battery
21 positive electrode current collector (positive electrode layer)
22 positive electrode active material layer (positive electrode layer)
31 negative electrode current collector (negative electrode layer)
32 lithium metal layer (negative electrode layer)
4, 4b solid electrolyte layer
5, 5b intermediate layer
61, 62 protective layer
L stacking direction

What is claimed is:

1. A lithium metal secondary battery having a negative electrode layer comprising a lithium metal layer, an intermediate layer, a solid electrolyte layer, and a positive electrode layer stacked in this order, wherein
at least one of outer peripheral surfaces of the intermediate layer along a stacking direction abuts against and is covered with a protective layer, and
the protective layer has ionic conductivity and no electron conductivity.

2. The lithium metal secondary battery according to claim 1, wherein the protective layer has an ionic conductivity equal to or higher than an ionic conductivity of the solid electrolyte layer.

3. The lithium metal secondary battery according to claim 1, wherein all of surfaces on a negative electrode layer side among surfaces of the protective layer perpendicular to the stacking direction abut against and are covered with an insulating layer.

4. The lithium metal secondary battery according to claim 1, wherein the protective layer is monolithically formed with the solid electrolyte layer.
